(19) United States
(12) Patent Application Publication
(10) Pub. No.: US 2008/0086746 A1
(43) Pub. Date: Apr. 10, 2008

(54) Simultaneously Viewing Multiple Programs Within A Television Program Guide

(76) Inventor: John Kelly King, Asheville, NC (US)

Correspondence Address: MERCHANT & GOULD PC, P.O. BOX 2903, MINNEAPOLIS, MN, 55402-0903, US

(21) Appl. No.: 11/868,217

(22) Filed: Oct. 5, 2007

Related U.S. Application Data
(60) Provisional application No. 60/850,033, filed on Oct. 6, 2006.

(51) Int. Cl. G06F 3/00

(52) U.S. Cl. 725/43

(57) ABSTRACT

Methods and systems are provided for viewing multiple television programs within a television program guide. A multiple tuner set-top box executes a client application for generating a program guide for tuning and recording television programs in a television services network. The client application receives a user selection of a program title displayed in the program guide while a program on a first tuner is being displayed within the program guide, tunes to the selected program on a second tuner, generates a window for displaying the selected program on the second tuner within the program guide, and displays the selected program in the window while displaying the program on the first tuner within the program guide. The client application also generates a user interface for receiving commands including switching from audio associated with the first tuner to audio associated with the second tuner and for recording the selected program on the second tuner.

### RELATED APPLICATION

Under provisions of 35 U.S.C. § 119(e), Applicant claims the benefit of U.S. provisional application No. 60/850,033 entitled “Methods And Systems for Simultaneously Viewing Multiple Programs Within A Television Program Guide,” filed Oct. 6, 2006, which is incorporated herein by reference.

### BACKGROUND

With the advent of modern television services networks, such as cable and satellite systems, subscribers have grown accustomed to receiving a variety of television programming from numerous broadcasting sources. In recent years, technology advances have enabled subscribers to receive an even greater variety of products and services through television services networks. For example, modern cable services networks provide traditional video television programming, telephone services, high speed Internet access, electronic mail services, video-on-demand, information services, and the like. Through the use of set-top boxes (computing systems), cable and satellite television services providers can provide interactive television services to subscribers. Such interactive television services allow customers to interact directly with service providers in response to services and product offerings presented to the subscribers through their television sets.

For example, some current television services networks are beginning to offer dual tuner set-top boxes equipped with digital video recorder (“DVR”) functionality to subscribers. Dual tuner DVR set-top boxes offer subscribers a number of features including the ability to record one program while watching another program and record two programs simultaneously. Some current dual-tuner DVR set-top boxes also include “picture-in-picture” functionality where subscribers can watch one program currently being broadcast on one tuner in full-screen and watch a second program currently being broadcast on a second tuner in a scaled video window. However, with current dual-tuner DVRs, there is no way to select or know which program is being broadcast on the second tuner without accessing a program guide which requires tuning away from the program currently being broadcast on the first tuner. It is with respect to these and other considerations that the present invention has been made.

### BRIEF SUMMARY

In accordance with the present invention, the above and other problems are solved by methods and systems for simultaneously viewing multiple programs within a television program guide.

According to one aspect of the invention, a method is provided for displaying a television program on a second tuner while displaying a program on a first tuner within a program guide provided by a television services network. The method includes receiving a selection in the program guide of a displayed program title identifying a currently airing program on the second tuner while the program on the first tuner is being displayed within the program guide. The method further includes, in response to receiving the selection of the program title, tuning to the currently airing program on the second tuner, generating a window for displaying the currently airing program on the second tuner within the program guide, and displaying the currently airing program in the window while displaying the program on the first tuner within the program guide. According to another aspect of the invention, the method includes generating a user interface for receiving commands including switching from audio associated with the first tuner to audio associated with the second tuner and recording the broadcast of the currently airing television program on the second tuner.

Various other aspects of the invention may be implemented by a multiple tuner set-top box in communication with a television services network. The set-top box executes a client application for generating a program guide for tuning and recording television programs in the television services network. The client application receives a user selection of a program title displayed in the program guide while a program on the first tuner is being displayed within the program guide, tunes to the selected program on a second tuner, generates a window for displaying the selected program on the second tuner within the program guide, and displays the selected program in the window while displaying the program on the first tuner within the program guide. The client application also generates a user interface for receiving commands including switching from audio associated with the first tuner to audio associated with the second tuner and for recording the selected program on the second tuner.

These and various other features, as well as advantages, which characterize the present invention, will be apparent from a reading of the following detailed description and a review of the associated drawings.

### BRIEF DESCRIPTION OF THE SEVERAL VIEWS OF THE DRAWINGS

FIG. 1 is a network diagram illustrating a cable services network architecture that serves as an illustrative operating environment for the present invention;

FIG. 2 is a flow diagram showing an illustrative routine for displaying a broadcast of a television program on a second tuner while displaying a broadcast of a program on a first tuner within an interactive program guide in the cable services network architecture of FIG. 1, according to an embodiment of the present invention;

FIG. 3 is a flow diagram showing an illustrative routine for displaying a broadcast of a television program on a second tuner while displaying a broadcast of a program on a first tuner within an interactive program guide in the cable services network architecture of FIG. 1, according to an embodiment of the present invention;

FIG. 4 is a simplified block diagram illustrating a television screen display of an interactive program guide for selecting television programs for viewing on a second tuner in a set-top box in the cable services network architecture of FIG. 1, according to an embodiment of the invention; and

FIG. 5 is a simplified block diagram illustrating a television screen display of a menu for selecting viewing options for a television program in the cable services network architecture of FIG. 1, according to an embodiment of the invention.

### DETAILED DESCRIPTION

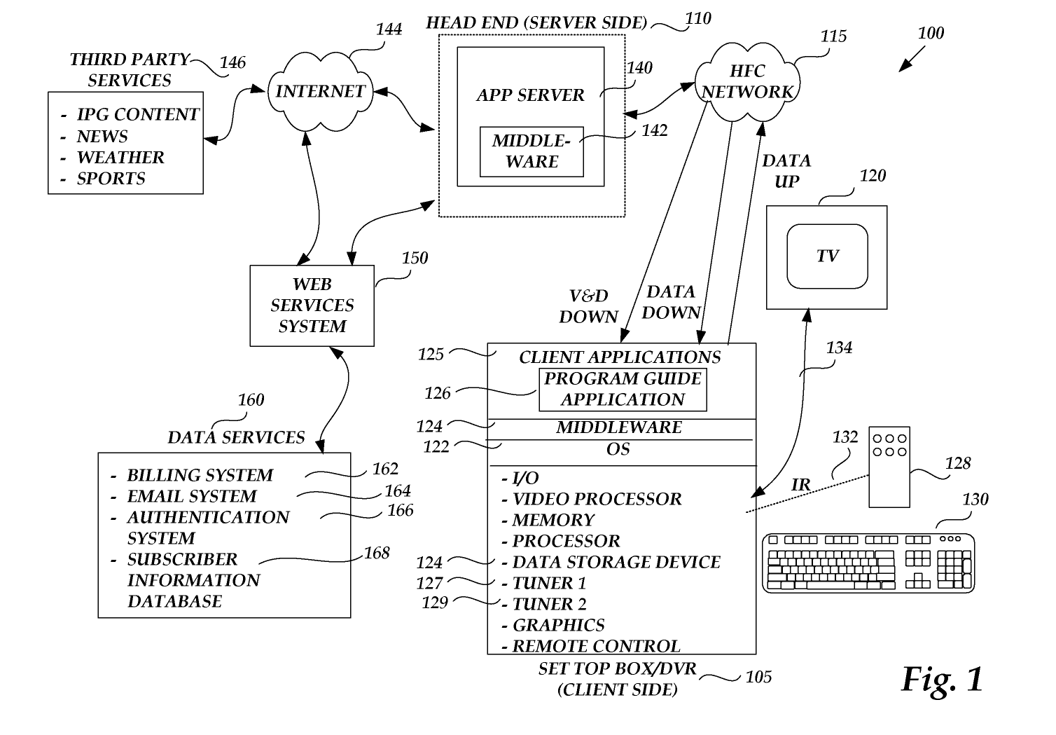

Referring now to the drawings, in which like numerals represent like elements, various embodiments of the present invention will be described. These embodiments may be combined, other embodiments may be utilized, and structural changes may be made without departing from the spirit or scope of the present invention. The following detailed description is therefore not to be taken in a limiting sense and the scope of the present invention is defined by the appended claims and their equivalents. According to an actual embodiment, the present invention is implemented in a cable television/services system in communication with one or more telecommunications sources. FIG. 1 is a block diagram illustrating a cable television/services system architecture (hereinafter referred to as “CATV” system) that serves as an illustrative operating environment for the present invention.

Referring now to FIG. 1, digital and analog video programming, information content and interactive television services are provided via a hybrid fiber coax (HFC) network 115 to a television set 120 for consumption by a cable television/services system customer. As is known to those skilled in the art, HFC networks 115 combine both optical fiber and coaxial cable lines. Typically, optical fiber runs from the cable head end 110 to neighborhoods of 500 to 2,000 customers. Coaxial cable runs from the optical fiber feeders to each customer. According to embodiments of the present invention, the functionality of the HFC network 115 allows for efficient bidirectional data flow between the client-side set-top box 105 and the server-side application server 140 of the present invention.

According to embodiments of the present invention, the CATV system 100 is in the form of a distributed client-server computing system for providing video and data flow across the HFC network 115 between server-side services providers (e.g., cable television/services providers) via a server-side head end 110 and a client-side customer via a client-side set-top box (set-top box) functionally connected to a customer receiving device, such as the television set 120. CATV systems may provide a variety of services across the HFC network 115 including traditional digital and analog video programming, telephone services, high speed Internet access, video-on-demand, and information services.

On the client side of the CATV system 100, digital and analog video programming and digital and analog data are provided to the customer television set 120 via the set-top box 105. Interactive television services that allow a customer to input data to the CATV system 100 likewise are provided by the set-top box 105. As illustrated in FIG. 1, the set-top box 105 is a multipurpose computing device having a computer processor, memory and an input/output mechanism. The input/output mechanism receives input from server-side processes via the HFC network 115 and from customers via input devices such as the remote control device 128 and the keyboard 130. The remote control device 128 and the keyboard 130 may communicate with the set-top box 105 via a suitable communication transport such as the infrared connection 132. The set-top box 105 also includes a video processor for processing and providing digital and analog video signaling to the television set 120 via a cable communication transport 134. Dual tuners 127 and 129 are provided for processing video and data to and from the set-top box 105 and the server-side head end system 110, described below. It should be understood that in accordance with various embodiments of the present invention, the set-top box 105 may include digital video recorder (“DVR”) functionality for recording television programs from the tuners 127 and 129 as data in a digital format (e.g., MPEG-1 or MPEG-2) and store the television data on a storage device, such as the data storage device 124, for later viewing.

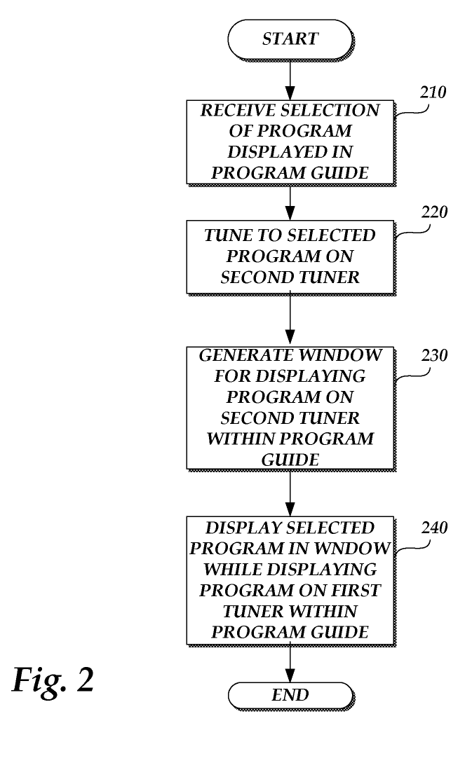

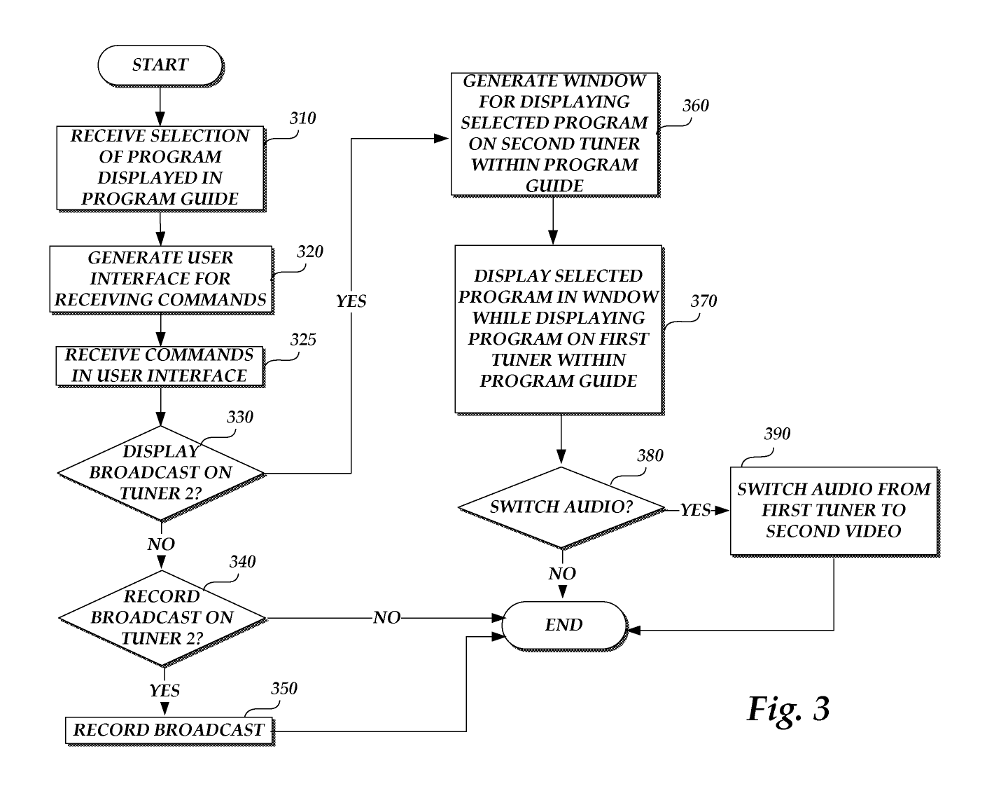

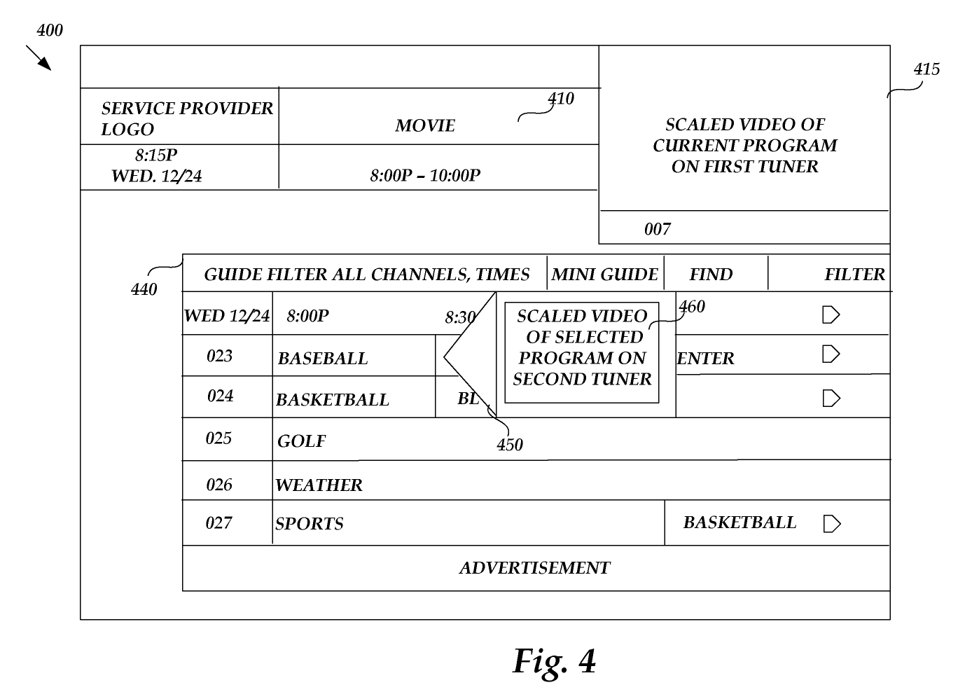

The set-top box 105 also includes an operating system 122 for directing the functions of the set-top box 105 in conjunction with a variety of client applications 125 including program guide application 126 for generating an interactive program guide (“IPG”) for presenting television program listings and other information to a customer on the television 120. For example, if the program guide application 126 requires updated television program listings from a third-party source to be displayed on the television 120, the operating system 122 may cause the graphics functionality and video processor of the set-top box 105, for example, to output the updated program listings to the television 120 at the direction of the program guide application 126. As will be understood by those skilled in the art, program guide data is typically received from a third-party source by the head end and is sent to the set-top box within a broadcast transport stream or alongside it in a special data channel. In accordance with one embodiment of the invention, the program guide application 126 is operative to display, within a program guide, a television program on a second tuner while a program on a first tuner is also being displayed. The functionality of the program guide application 126 will be described in greater detail below with respect to FIGS. 2-3. An illustrative television screen display of a program guide in accordance with an embodiment of the present invention is shown in FIG. 4, which will be described in detail below.

Because a variety of different operating systems 122 may be utilized by a variety of different brands and types of set-top boxes, a middleware layer 124 is provided to allow a given software application to be executed by a variety of different operating systems. The middleware layer 124 may include a set of application programming interfaces (“APIs”) that are exposed to the client applications 125 and operating systems 122 that allow the client applications to communicate with the operating systems through common data calls understood via the API set. As described below, a corresponding middleware layer is included on the server side of the CATV system 100 for facilitating communication between a server-side application server and the client-side set-top box 105. According to one embodiment of the present invention, the middleware layer 142 of the server-side application server 140 and the middleware layer 124 of the client-side set-top box 105 format data passed between the client side and server side according to the Extensible Markup Language (“XML”).

The set-top box 105 passes digital and analog video and data signaling to the television 120 via a one-way communication transport 134. The set-top box 105 may receive video and data from the server side of the CATV system 100 via the HFC network 115 through a video/data downlink and data via a data downlink. The set-top box 105 may transmit data from the client side of the CATV system 100 to the server side of the CATV system 100 via the HFC network 115 via one data uplink. The video/data downlink is an “in band” downlink that allows for digital and analog video and data signaling from the server side of the CATV system 100 through the HFC network 115 to the set-top box 105 for use by the set-top box 105 and for distribution to the television set 120. As is understood by those skilled in the art, the “in band” signaling space operates at a frequency between 54 and 860 megahertz. The signaling space between 54 and 860 megahertz is generally divided into 6 megahertz channels in which may be transmitted a single analog signal or a greater number (e.g., up to ten) digital signals.

The data downlink and the data uplink, illustrated in FIG. 1, between the HFC network 115 and the set-top box 105 comprise “out of band” data links. As is understand by those skilled in the art, the “out of band” frequency range generally lies between zero and 54 megahertz. According to embodiments of the present invention, data flow between the client-side set-top box 105 and the server-side application server 140 is typically passed through the “out of band” data links. Alternatively, an “in band” data carousel may be positioned in an “in band” channel into which a data feed may be processed from the server-side application server 140 through the HFC network 115 to the client-side STB 105. Operation of data transport between components of the CATV system 100, described with reference to FIG. 1, is well known to those skilled in the art.

Referring still to FIG. 1, the head end 110 of the CATV system 100 is positioned on the server side of the CATV system 100 and includes hardware and software systems responsible for originating and managing content, including broadcast video sources, for distributing through the HFC network 115 to client-side set-top boxes 105 for presentation to customers via televisions 120. As described above, a number of services may be provided by the CATV system 100, including digital and analog video programming, interactive television services, telephone services, video-on-demand services, targeted advertising, and provision of information content.

The application server 140 is a general-purpose computing system operative to assemble and manage data sent to and received from the client-side set-top box 105 via the HFC network 115. As described above with reference to the set-top box 105, the application server 140 includes a middleware layer 142 for processing and preparing data from the head end of the CATV system 100 for receipt and use by the client-side set-top box 105. For example, the application server 140 via the middleware layer 142 may obtain data from third-party services 146 via the Internet 140 for transmitting to a customer through the HFC network 115 and the set-top box 105. For example, as briefly described above, television program guide data from a third-party service may be downloaded by the application server via the Internet 144. When the application server 140 receives the downloaded data, the middleware layer 142 may be utilized to format the program guide data for receipt and use by the set-top box 105. According to one embodiment of the present invention, data obtained and managed by the middleware layer 142 of the application server 140 is passed to the set-top box 105 through the HFC network 115 where the data may be utilized by the program guide application 126 in concert with the middleware layer 124, as described above. In addition to program guide data, it will be appreciated by those skilled in the art that a variety of third-party services data, including news data, weather data, and sports data may be obtained by the application server 140 via distributed computing environments such as the Internet 144 for provision to customers via the HFC network 115 and the set-top box 105.

As illustrated in FIG. 1, the data services 160 include a number of services operated by the services provider of the CATV system 100 including a billing system 162, an electronic mail system 164, an authentication system 166, and a subscriber information database 168. As should be understood by those skilled in the art, the disparate data services systems 162, 164, 166, 168 are illustrated as a collection of data services for purposes of example only. The example data services systems comprising the data services 160 may operate as separate data services systems, which communicate with a web services system (described below) along a number of different communication paths and according to a number of different communication protocols.

Referring still to FIG. 1, a web services system 150 is illustrated between the application server 140 and the data services 160 and serves as a collection point for data requested from each of the disparate data services systems comprising the data services 160. The web services system 150 serves as an abstraction layer between the various data services systems and the application server 140. That is, the application server 140 is not required to communicate with the disparate data services systems, nor is the application server 140 required to understand the data structures or data types utilized by the disparate data services systems.

FIGS. 2-3 are flow diagrams showing illustrative routines performed by the program guide application 126 executed in the set-top box 105 for displaying a broadcast of a television program on a second tuner while displaying a broadcast of a program on a first tuner within a program guide. Referring now to FIG. 2, the routine 200 begins at operation 210, where the program guide application 126 generates an interactive program guide and receives a selection of a broadcast television program title which is currently displayed in the program guide. It should be understood that the program guide (i.e., IPG), in addition to displaying television program listings, also displays a scaled video window of a currently airing program on one of the tuners in the set-top box 105. In the various embodiments of the invention, the program guide application 126 provides a graphical user interface (“GUI”) including a visual element, such as a pointer, which enables subscriber to navigate listings in the IPG as well as initiate commands. In selecting a program title in the program guide, a subscriber may utilize the remote control device 128 to control the pointer and navigate television program titles in the IPG until a program of interest is found. Once a program of interest is found, the subscriber may hover or pause over the program title in the IPG to select it. According to one embodiment of the present invention, the program of interest may be a television program currently being recorded from a second tuner (i.e., the tuner not receiving the program being displayed in the scaled video window) using the DVR functionality of the set-top box 105.

The routine 200 continues from operation 210 at operation 220, where the program guide application 126, in response to the subscriber selection of the program title, tunes to the program of interest on the second tuner (and optionally being recorded by the DVR) in the set-top box 105. It should be understood that the set-top box tunes to the program of interest on the second tuner in the background while the IPG, including the scaled video window of the currently airing program on the alternate (i.e., first) tuner, is being displayed.

The routine 200 continues from operation 220 at operation 230, where the program guide application 126, after tuning to the program of interest in the background, generates a window within the program guide to display the program of interest being broadcast on the second tuner. In particular, according to one embodiment of the invention, a reduced scale video window for displaying the program being broadcast on the second tuner is generated adjacent to the selected program title in the IPG.

The routine 200 continues from operation 230 at operation 240, where the program guide application 126 instructs the set-top box to display the program being broadcast on the second tuner in the reduced scale video window generated in the program guide. It will be appreciated that by displaying the program being broadcast on the second tuner within the program guide allows a subscriber to “peek” at a particular television programs of interest while simultaneously able to view a program being broadcast on the first tuner. After the operation 240, the routine 200 then ends.

Referring now to FIG. 3, the routine 300 begins at operation 310, where the program guide application 126 generates an IPG and receives a selection of a broadcast television program title which is currently displayed in the program guide. It will be appreciated that the program title is for a program of interest being broadcast (and optionally being recorded by a DVR) on a second tuner in the set-top box 105 and may be selected by a subscriber using the remote control device 128. In particular, a subscriber using the remote control device 128 may use a pointer or other visual element to navigate the IPG to a program title and, according to an embodiment of the present invention, select the program of interest by, for example, pressing an “Info” button.

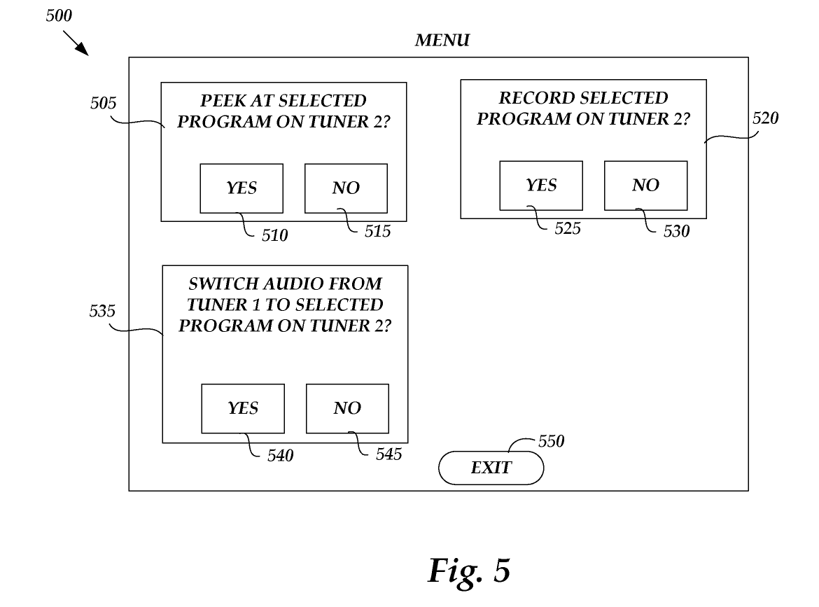

The routine 300 continues from operation 310 at operation 320, where the program guide application 126, in response to the subscriber selection of the program title, generates menu comprising a user interface for receiving commands related to viewing the selected program being broadcast on the second tuner. An illustrative television screen display shown a menu in accordance with an embodiment of the present invention is shown in FIG. 5 which will be discussed in detail below.

The routine 300 continues from operation 320 at operation 325, where the program guide application 126 receives commands in the user interface related to viewing the selected program. The routine 300 continues from operation 325 at operation 330 where the program guide application 126 determines if a command is received to display the selected program (i.e., “peek”) on a second tuner within the IPG.

If, at operation 330, the program guide application 126 determines that a command was received to display the selected program on a second tuner, then the routine 330 branches to operation 360 where the program guide application 126 generates a reduced scale video window within the IPG for displaying the program of interest being broadcast on the second tuner. The routine 300 then continues from operation 360 at operation 370, where the program guide application 126 instructs the set-top box to display the program being broadcast on the second tuner in the reduced scale video window generated in the program guide while also displaying the program being broadcast on the first tuner.

The routine 300 continues from operation 370 at operation 380 where the program guide application 126 determines if a command was received to switch the current audio feed being sent to the television 120 from the first tuner to the second tuner. If, at operation 380, the program guide application 126 determines that a command was received to switch the current audio feed from the first tuner to the second tuner, then the routine 300 continues at operation 390 where the program guide application 126 instructs the set-top box 105 to do so. It should be understood that when the IPG is initially displayed by the program guide application 126, audio associated with the program being broadcast on the first tuner and displayed in the scaled video window is communicated from the set-top box 105 to the television 120. By receiving a command to switch the audio feeds, the program guide application 126 instructs the set-top box to switch the audio feed from the first tuner to the second tuner on which the program selected by the subscriber at operation 310 is being broadcast. If, at operation 380, the program guide application 126 determines that no command was received to switch the current audio feed, then the routine 300 ends.

Returning now to operation 330, if, at operation 330, the program guide application 126 determines that no command was received to display the selected program on a second tuner, then the routine 300 continues at operation 340 where the program guide application 126 determines if a command was received to record the selected program on the second tuner (in a set-top box having DVR functionality). If, at operation 340, the program guide application 126 determines that a command was received to record the selected program on the second tuner, then the routine 300 continues at operation 350 where the program guide 126 instructs the set-top box/DVR to begin recording the selected program. It should be understood that if the program guide application 126 determines that the selected program is already being recorded, then the command is ignored. From operation 350, the routine 300 ends. If, at operation 340, the program guide application 126 determines that a command was not received to record the selected program on the second tuner, then the routine 300 also ends.

FIG. 4 is a simplified block diagram illustrating a television screen display of an IPG showing a scaled video window of a selected program being broadcast on second tuner, in accordance with an embodiment of the invention. It should be understood that the layout and content of the television screen displays illustrated in FIGS. 4-5 are for purposes of example only and are not limiting of the variety of different layouts and types of content that may be included in such displays according to illustrative embodiments of the present invention.

Referring now to FIG. 4, the television screen display 400 includes an IPG including a channel description 410 of a currently tuned program being broadcast on a first tuner in the set-top box 105, a scaled video window 415 of the currently tuned program, and a listing 440 of currently airing television programs in the CATV system 100. The television display 400 also includes a pointer 470 generated by the program guide application 126 for navigating among the program titles in the listing 440 and for selecting program titles to be tuned on the second tuner in the set-top box 105. The television display also includes a scaled video window 460, which is generated by the program guide application 126 in response to the selection of a program from the listing 440 for viewing a selected program on a second tuner in the set-top box 105.

Referring now to FIG. 5, the television screen display 500 includes a menu generated by the program guide application 126 in response to selecting a program from the IPG described in FIG. 4, according to one embodiment of the invention. The menu includes a selection box 505 for selecting whether to “peek” (i.e., view in a scaled video window within the IPG) at the selected program which is currently being broadcast on a second tuner in the CATV system 100 by selecting boxes “Yes” 510 or “No” 515. The menu also includes a selection box 520 for selecting whether to record a selected program being broadcast on the second tuner by selecting boxes “Yes” 525 or “No” 530. The menu also includes a selection box 535 for selecting whether to switch program audio from a program currently airing on a first tuner in the set-top box 105 to the program selected for viewing on the second tuner on the set-top box 105, by selecting boxes “Yes” 540 or “No” 545. The menu also includes an “Exit” button for leaving the menu and returning to the IPG.

Based on the foregoing, it should be appreciated that the various embodiments of the invention include methods and systems for simultaneously viewing multiple programs within a television program guide. The above specification, examples and data provide a complete description of the manufacture and use of the composition of the invention. Since many embodiments of the invention can be made without departing from the spirit and scope of the invention, the invention resides in the claims hereinafter appended.

We claim:

1. A method of displaying a program on a second tuner while a program on a first tuner is being displayed within a program guide provided by a television services network, comprising:
receiving a selection of a program title displayed in the program guide while the program on the first tuner is being displayed within the program guide, wherein the program title identifies the program on the second tuner, wherein the program on the second tuner is a currently airing program in the television services network;
in response to receiving the selection of the program title, tuning to the program on the second tuner;
generating a window for displaying the currently airing program on the second tuner within the program guide; and
displaying the currently airing program in the window while displaying the program on the first tuner within the program guide.

2. The method of claim 1, wherein receiving a selection of a program title displayed in the program guide comprises hovering a pointer over the program title displayed in the program guide in response to a user action, wherein the program identified by the program title is currently being recorded within a set-top box in communication with the television services network.

3. The method of claim 1, wherein tuning to the program on the second tuner comprises tuning to the program on the second tuner within a set-top box in communication with the television services network while the program on the first tuner is being displayed within the program guide.

4. The method of claim 1, wherein generating a window for displaying the currently airing program on the second tuner within the program guide comprises generating a reduced scale video window for displaying the currently airing program.

5. The method of claim 1, wherein displaying the currently airing program in the window while displaying the program on the first tuner within the program guide further comprises displaying the program on the first tuner in a reduced scale video window within the program guide.

6. A method of displaying a program on a second tuner while a program on a first tuner is being displayed within a program guide provided by a television services network, comprising:
receiving a selection of a program title displayed in the program guide while the program on the first tuner is being displayed within the program guide, wherein the program title identifies the program on the second tuner, wherein the program on the second tuner is a currently airing program in the television services network; and
generating a user interface for receiving a plurality of commands including displaying the currently airing program in a window while displaying the program on the first tuner within the program guide and switching from audio associated with the first tuner to audio associated with the second tuner.

7. The method of claim 6 further comprising receiving commands, within the user interface, for recording the currently airing program on the second tuner.

8. A system for displaying a program on a second tuner while a program on a first tuner is being displayed within a program guide provided by a television services network, comprising a multiple tuner set-top box in communication with the television services network, the set-top box operative to execute a client application for generating a program guide for tuning to the programs on the first and second tuners, the client application further operative to:
receive a selection of a program title displayed in the program guide while the program on the first tuner is being displayed within the program guide, wherein the program title identifies the program on the second tuner, wherein the program on the second tuner is a currently airing program in the television services network;
in response to receiving the selection of the program title, tuning to the program on the second tuner;
generate a window for displaying the currently airing program on the second tuner within the program guide; and
display the currently airing program in the window while displaying the program on the first tuner within the program guide.

9. The system of claim 8, wherein the client application is further operative to hover a pointer over the program title displayed in the program guide in response to a user action, wherein the program identified by the program title is currently being recorded by the set-top box.

10. The system of claim 9, wherein the client application, in wherein tuning to the program on the second tuner, is further operative to tune to the program on the second tuner while the program on the first tuner is being displayed within the program guide.

11. The system of claim 9, wherein the client application is further operative to generate a reduced scale video window for displaying the currently airing program.

12. The system of claim 9, wherein the client application is further operative to display the program on the first tuner in a reduced scale video window within the program guide.

13. A system for displaying a program on a second tuner while a program on a first tuner is being displayed within a program guide provided by a television services network, comprising a multiple tuner set-top box in communication with the television services network, the set-top box operative to execute a client application for generating a program guide for tuning to the programs on the first and second tuners, the program guide application further operative to:
receive a selection of a program title displayed in the program guide while the program on the first tuner is being displayed within the program guide, wherein the program title identifies the program on the second tuner, wherein the program on the second tuner is a currently airing program in the television services network; and
generate a user interface for receiving a plurality of commands including displaying the currently airing program in a window while displaying the program on the first tuner within the program guide and switching from audio associated with the first tuner to audio associated with the second tuner.

14. The system of claim 13, wherein the client application is further operative to receive commands for recording the currently airing program on the second tuner.
